(19) United States
(12) Patent Application Publication
(10) Pub. No.: US 2003/0094071 A1
(43) Pub. Date: May 22, 2003

(54) Foot pedal lift assist

(75) Inventors: Jimmy N. Eavenson SR., Aurora, OH (US); Gary Hobrath, Brunswick, OH (US); Dan Morse, Burbank, OH (US)

Correspondence Address: EMERSON & SKERIOTIS, Fourteenth Floor, One Cascade Plaza, Akron, OH, 44308-1136, US

(73) Assignee: MTD PRODUCTS INC, Cleveland, OH

(21) Appl. No.: 09/993,162

(22) Filed: Nov. 19, 2001

(51) Int. Cl. G05G 1/16

(52) U.S. Cl. 74/562

(57) ABSTRACT

A foot pedal lift assist that is operably associated with the lift mechanism of a lawn care apparatus. The lift assist includes a foot pedal that is pivotally connected to a holder. The foot pedal may be locked into an operative position where the longitudinal axis of the foot pedal is perpendicular to the axis of the holder. The foot pedal includes a positioning hole that is aligned with a first hole on a mounting surface of the holder when the foot pedal is in the operative position. The foot pedal may be locked into an inoperative position where the longitudinal axis of the foot pedal is parallel to the axis of the holder. The positioning hold of the foot pedal is aligned with a second hold on the mounting surface when the foot pedal is in the inoperative position. The foot pedal lift assist may be used alone, or in conjunction with a standard hand lever to reposition a mower deck or other implement.

### BACKGROUND OF THE INVENTION

1. Field of Invention

This invention pertains to the art of methods and apparatuses for providing a lift assist mechanism to raise or lower the mowing deck or other implement used in association with a lawn care apparatus. More specifically, the invention provides a lift assist having a foot pedal that pivots between an operative position and an inoperative position. The foot pedal lift assist can be used in conjunction with a hand-operated lever, or used alone to change the mower deck height.

2. Description of the Related Art

In the art it is known to provide lawn care vehicles with means to raise and lower the mower deck in order to provide a range of cutting heights at which the cutting blade operates. Manual lift mechanisms generally require the operator to manipulate a hand lever in order to reposition the mower deck. Depending on the lawn care apparatus, the operator may be required to exert a relatively large amount of force to the hand lever.

It is also known in the art to provide a lift assist mechanism whereby an operator can exert pressure against a foot pedal in order to reposition the mower deck. The lift assist mechanisms known in the art include an arm that extends upward from the mower deck and a foot pedal extending generally perpendicular to the arm. The foot pedal is maintained in a fixed position relative to the arm. The TORO® Z Master 256E ZRT provides an example of a foot deck lift assist wherein the foot pedal is fixed relative to the arm. The position of the foot pedal is such that the operator's foot may readily engage it when the operator is seated. While the lift assist mechanisms known in the art make the foot pedal accessible to a seated operator, the fixed foot pedal position hinders the ingress, egress and other motions of the operator.

There is therefore a need in the art for a foot pedal lift assist mechanism that has an operable position that is readily accessible to an operator, while providing an inoperable position that does not hinder the actions of the operator.

There is further a need in the art to provide a lift assist mechanism wherein the foot pedal can be moved to a position that allows the foot platform to be tilted for access to some of the machine components.

The present invention provides advantages over the lift assist mechanisms known in the art that is simple in construction and inexpensive to produce. In addition, the lift assist mechanism of the present invention may be adapted to be retrofitted to existing lawn care apparatuses.

### SUMMARY OF THE INVENTION

In accordance with the present invention, there is provided a lift assist assembly including a foot pedal that is selectively moveable from an operative position to an inoperative position.

According to one aspect of the invention, a lift assist assembly is adapted to be operably associated with a lift mechanism of an associated lawn care apparatus. The lift assembly comprises a foot pedal that is selectively moveable between an operative position and an inoperable position.

According to another aspect of the invention, the operative position is offset from the inoperative position by approximately 90°.

According to another aspect of the invention, the lift assist assembly comprises a foot pedal that is selectively moveable between an operative position and an inoperable position; a holder; means for pivotally mounting said pedal to said holder; and, means for selectively locking said pedal in either said operative position or said inoperative position.

According to another aspect of the invention, the said holder is associated with a first longitudinal axis and the foot pedal is associated with a second longitudinal axis and wherein when the foot pedal is in the operative position, the second longitudinal axis forms an angle with the first longitudinal axis of approximately 90°.

According to another aspect of the invention, when the foot pedal is in the inoperative position, the second longitudinal axis is generally parallel to the first longitudinal axis.

According to another aspect of the invention the foot pedal includes a generally centrally located opening and the holder includes a mounting surface having an aperture therein. The means for mounting the pedal to the holder includes a pivot pin being received through the generally centrally located opening in the foot pedal and through the aperture of the mounting surface.

According to another aspect of the invention, the foot pedal is adapted to remain pivotally secured to the holder when the foot pedal is selectively moved between the operative position and said inoperative position.

According to another aspect of the invention, the holder includes a notched region adapted to selectively engage the lift mechanism of the associated lawn care apparatus.

According to another aspect of the invention, the lift assembly further comprises means for operably connecting the lift assist assembly to the associated lawn care apparatus.

According to another aspect of the invention, the foot pedal includes a positioning hole and the holder includes a mounting surface having first and second holes therein. When the foot pedal is in operative position, said positioning hole is aligned with the first hole and when the foot pedal is in the inoperative position, said positioning hole is aligned with the second hole.

According to another aspect of the invention, the means for selectively locking the foot pedal in either the operative position or the inoperative position includes a locking pin. The locking pin is selectively insertable through the aligned positioning hole and the first hole or through the aligned positioning hole and the second hole.

One advantage of the invention is that the foot pedal on the lift assist assembly may be placed in an inoperable position to allow ease of movement to the operator.

Another advantage of the invention is that the lift assist assembly may be retrofitted on earlier models of lawn care equipment.

Another advantage of the invention is that the lift assist can be used in conjunction with the hand lever to provide the desired lift assist, or used alone, without the hand lever, to reposition the mower deck or other implement.

Another advantage of the invention is that the foot pedal may be placed in the inoperable position to allow hand effort only to reposition the mower deck.

Another advantage of the invention is that the foot pedal can be moved out of the way to provide access to the vehicle components positioned beneath the foot platform.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows an exploded view of a preferred embodiment of the lift assist according to the invention;

FIG. 2 shows a perspective view of the embodiment of FIG. 1 wherein the foot pedal is in the operative position;

FIG. 3 shows a front view of a holder in accordance with the invention;

FIG. 4 shows a front view of the embodiment of FIG. 1 wherein the foot pedal is in the operative position;

FIG. 5 shows a front view of the embodiment of FIG. 1 wherein the foot pedal is in the inoperative position; and,

FIG. 6 shows a perspective view of a lawn care apparatus including a lift assist according to the invention.

### DESCRIPTION OF THE PREFERRED EMBODIMENT

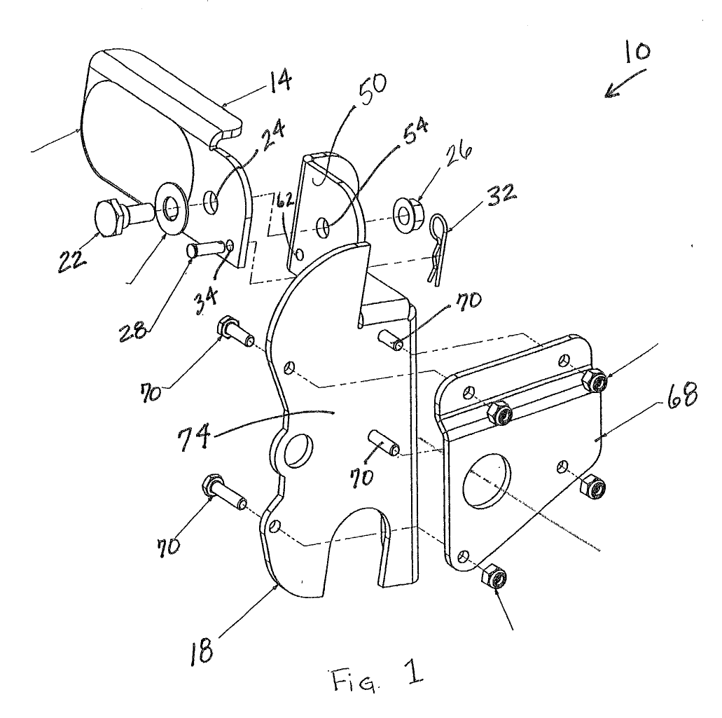

Referring now to the drawings wherein the showings are for purposes of illustrating a preferred embodiment of the invention only and not for purposes of limiting the same, FIG. 1 shows a preferred embodiment of a foot pedal lift assist assembly 10 according to the invention. The lift assist assembly 10 includes foot pedal 14 adapted to be selectively mountable to holder 18. In the preferred embodiment, foot pedal 14 is pivotally mounted to holder 18 by pivot pin 22. Pivot pin 22 is adapted to be received through a generally central opening 24 in foot pedal 14. Foot pedal 14 is adapted to pivot about an axis of pivot pin 22 between first and second pre-selected positions as will be discussed in further detail below. The first pre-selected position is termed “operable” because the foot pedal 14 is readily accessible to an operator for convenient use. The second pre-selected position is termed “inoperable” because the foot pedal 14 is less accessible to an operator and in an inconvenient position. The pivot pin 22 is adapted to be retained in position by nut 26. Therefore, as foot pedal 14 is moved between the first and second pre-selected positions, the foot pedal 14 remains fastened to holder 18 by pivot pin 22 and nut 26. Other means for pivotally mounting foot pedal 14 to holder 18 are within the scope of the present invention.

In the preferred embodiment, foot pedal 14 is selectively maintained in either the first or second pre-selected position by use of locking pin 28 and hairpin 32. It is within the scope of the invention to employ any other means that function to maintain the foot pedal 14 in the pre-selected position. For instance, other types of locking mechanisms, such as cotter pins, wing nuts, etc. may be utilized. Locking pin 28 is adapted to be received through a positioning hole 34 in foot pedal 14. Positioning hole 34 is spaced from central opening 24 and changes position relative to holder 18 as foot pedal 14 pivots about pivot pin 22.

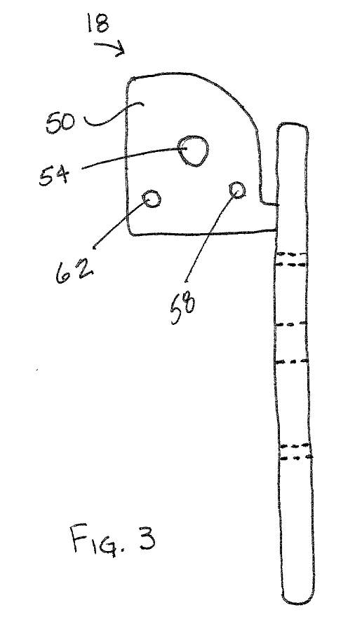

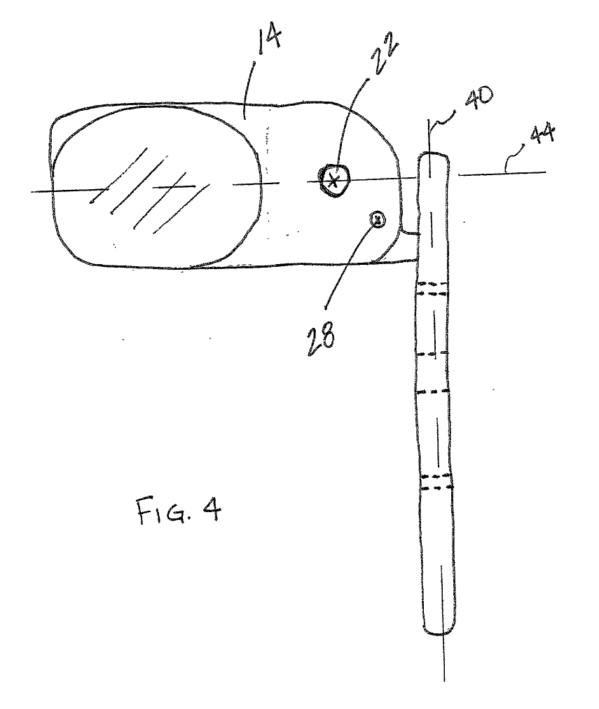

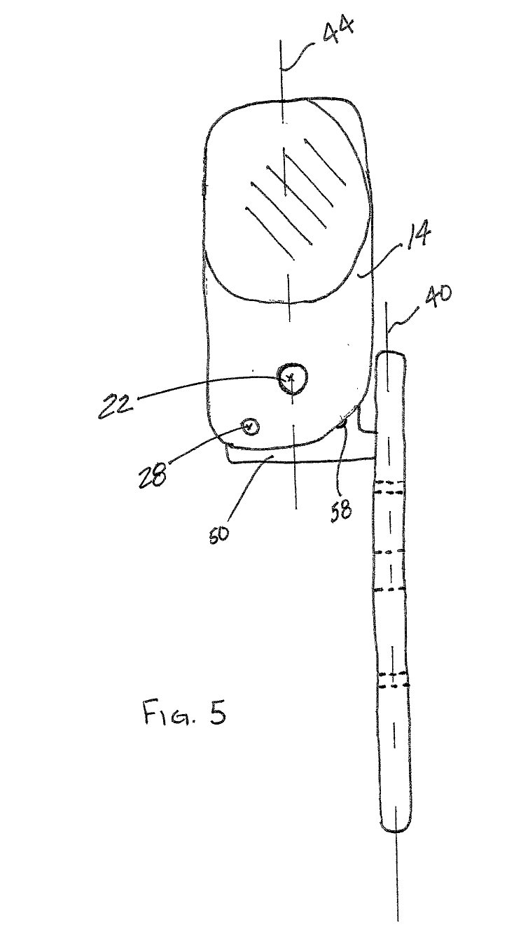

With reference to FIGS. 3-5, holder 18 is associated with a longitudinal axis 40. Foot pedal 14 is associated with a longitudinal axis 44. When foot pedal 14 is in the operable position (FIG. 4), the longitudinal axis 44 of the foot pedal 14 is generally perpendicular to the longitudinal axis 40 of holder 18. When the foot pedal 14 is in the inoperable position (FIG. 5), the longitudinal axis 44 of the foot pedal 14 is generally parallel to the longitudinal axis 40 of the holder 18. In the preferred embodiment, the operative position of the foot pedal 14 is offset approximately 90° from the inoperative position of the foot pedal 14. As shown in FIGS. 4 and 5, foot pedal 14 is generally rectangular, and the longitudinal axis is associated with its longest dimension.

With particular reference to FIG. 3, holder 18 includes a generally planar mounting surface 50. Aperture 54 is adapted to receive pivot pin 22. There is further provided a first hole 58 and a second hole 62 through mounting surface 50. First hole 58 and second hole 62 are adapted to selectively receive locking pin 28.

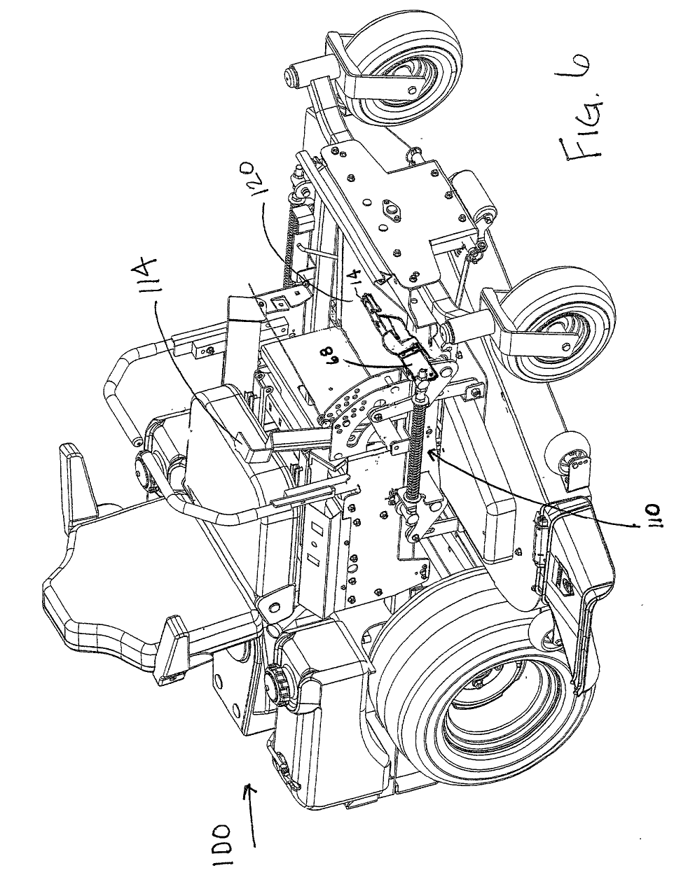

With particular reference to FIGS. 1, 2 and 6, the lift assist assembly 10 is adapted to engage an existing lift mechanism, shown generally as 110 in FIG. 6, in an associated lawn care apparatus 100. In the preferred embodiment, the holder 18 includes means for connecting the lift assist assembly 10 to an associated lawn care apparatus. In the preferred embodiment, holder 18 cooperates with bracket 68 and various attaching members 70 to connect the lift assembly 10 to an associated lawn care apparatus 100. It is within the scope of the present invention to provide means other than bracket 68 and attaching members 70 to accomplish the same result.

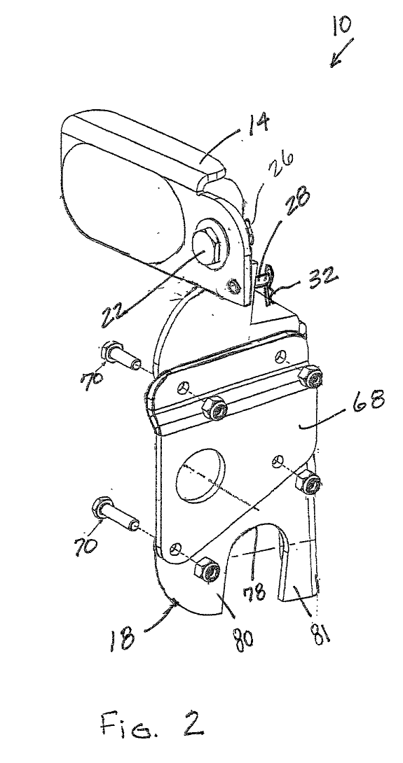

With particular reference to FIGS. 1 and 2, in the preferred embodiment, holder 18 includes sidewall 74 having a notched region. In the preferred embodiment, the notched region includes an inverted-U-shaped notch 78. The prongs 80, 81 of the inverted-U notch 78 are adapted to engage the lift mechanism of the associated lawn care apparatus. It is within the scope of the present invention to provide means other than the inverted-U notch 78 to engage the lift mechanism.

As illustrated in FIG. 6, the lift assist assembly 10 of the present invention can be used in conjunction with a hand lever 114 of an associated lawn care apparatus to provide “lift assist”. The lift assist assembly 10 may also be used without the hand lever 114 so that foot effort only is used to reposition the mower deck or other implement. The foot pedal 14 may also be placed in the inoperative position whereby only hand effort is used to raise or lower the deck.

The use of the lift assist assembly 10 of the present invention will now be described. For example, the starting position may be when the foot pedal 14 is in the inoperable position, the positioning hole 34 is aligned with the second hole 62 in mounting surface 50, the locking pin is inserted through positioning hole 34 and second hole 62, and the hair pin 32 is inserted through the locking pin 28.

In order to move the foot pedal 14 into the operative position, the operator removes the hairpin 32 and removes the locking pin 28. The foot pedal 14 is rotated about pivot pin 22 until the positioning hole 34 is aligned with first hole 58 in mounting surface 50. The operator inserts the locking pin through positioning hole 34 and first hole 58 and reinstalls the hairpin 32.

To use the lift assist assembly 10 with the hand lever of an associated lawn care apparatus, the operator pulls on the hand lever while depressing the foot pedal in order to raise the lift mechanism of the associated lawn care apparatus. The lift mechanism can then be held in a stationary position through foot effort only while the lift height setting pin is removed and repositioned (if applicable according to lawn mower type).

To use the lift assist assembly 10 alone, without hand effort, the foot pedal is depressed in order to raise the lift mechanism.

In the preferred embodiment, the hand lever will lock into the “transport” position if the foot pedal is fully depressed. To release the lift mechanism from the transport position, the operator depresses the foot pedal, moves the hand lever toward the operator's right side of the machine, then while maintaining the lever toward the right side, the operator reduces foot pedal effort to allow the lift mechanism to be lowered.

The lift assist assembly 10 is adapted to allow hand lever effort only. The foot pedal 14 is moved into the inoperative position by reversing the actions described above. The hairpin 32 is removed from the locking pin 28. The foot pedal 14 is rotated in an opposite direction about pivot pin 22 until positioning hole 34 aligns with second hole 62. The locking pin 28 is inserted through the positioning hole 34 and second hole 62. Then the hairpin 32 is reinserted through locking pin 28.

When the foot pedal 14 is in the inoperative position, its longitudinal axis 44 is aligned generally parallel to the longitudinal axis 40 of holder 18. In the preferred embodiment, in this position, the foot pedal 14 allows the foot platform 120 (FIG. 6) to be tilted in order to provide access to machine components. Also, when the foot pedal 14 is in the inoperative position, the operator's motions are less encumbered.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

What is claimed is:

1. A lift assist assembly adapted to be operably associated with a lift mechanism of an associated lawn care apparatus, the lift assist assembly comprising:
a foot pedal, said foot pedal being selectively moveable between an operative position and an inoperable position.

2. The lift assist assembly of claim 1 wherein said operative position is offset from said inoperative position by approximately 90°.

3. A lift assist assembly adapted to be operably associated with a lift mechanism of an associated lawn care apparatus, the lift assist assembly comprising:
a foot pedal, said foot pedal being selectively moveable between an operative position and an inoperable position;
a holder;
means for pivotally mounting said foot pedal to said holder; and,
means for selectively locking said foot pedal in either said operative position or said inoperative position.

4. The lift assist assembly of claim 3 wherein said holder is associated with a first longitudinal axis and said foot pedal is associated with a second longitudinal axis and wherein when said foot pedal is in said operative position, said second longitudinal axis forms an angle with said first longitudinal axis of approximately 90°.

5. The lift assist assembly of claim 3 wherein said holder is associated with a first longitudinal axis and said foot pedal is associated with a second longitudinal axis and wherein when said foot pedal is in said inoperative position, said second longitudinal axis is generally parallel to said first longitudinal axis.

6. The lift assist assembly of claim 3 wherein:
said foot pedal includes a generally centrally located opening and said holder includes a mounting surface having an aperture therein;
and wherein:
said means for mounting said pedal to said holder includes a pivot pin, said pivot pin being received through said generally centrally located opening in said foot pedal and through said aperture of said mounting surface.

7. The lift assist assembly of claim 3 wherein:
said foot pedal is adapted to remain pivotally secured to said holder when said foot pedal is selectively moved between said operative position and said inoperative position.

8. The lift assist assembly of claim 3 wherein:
said holder includes a notched region adapted to selectively engage the lift mechanism of the associated lawn care apparatus.

9. The lift assist assembly of claim 3 further comprising:
means for operably connecting said lift assist assembly to the associated lawn care apparatus.

10. The lift assist assembly of claim 3 wherein:
said foot pedal includes a positioning hole, and
said holder includes a mounting surface having first and second holes therein, and wherein when said foot pedal is in said operative position, said positioning hole is aligned with said first hole and when said foot pedal is in said inoperative position, said positioning hole is aligned with said second hole.

11. The lift assist assembly of claim 10 wherein:
said means for selectively locking said foot pedal in either said operative position or said inoperative position includes a locking pin, said locking pin being selectively insertable through said aligned positioning hole and said first hole or through said aligned positioning hole and said second hole.
